(19) United States
(12) Patent Application Publication
(10) Pub. No.: US 2026/0120707 A1
(43) Pub. Date: Apr. 30, 2026

(54) VIDEO CONFERENCE TERMINAL, METHOD FOR PROCESSING VIDEO CONFERENCE SYSTEM, AND PROGRAM

(71) Applicant: VAIO Corporation, Nagano (JP)

(72) Inventors: Masanao TSUTSUI, Nagano (JP); Kazuya OSAKA, Nagano (JP); Yuki SHIBATA, Nagano (JP); Daisuke KUROSAKI, Nagano (JP); Yasushi SHINOHARA, Nagano (JP)

(21) Appl. No.: 19/370,765

(22) Filed: Oct. 28, 2025

(30) Foreign Application Priority Data
Oct. 30, 2024 (JP) 2024-190519
Sep. 29, 2025 (JP) 2025-161315

(51) Int. Cl. G10L 21/0364; G06T 11/00; G10L 21/034; G10L 25/57

(52) U.S. Cl. CPC G10L 21/0364; G06T 11/00; G10L 21/034; G10L 25/57

(57) ABSTRACT

To realize a smooth video conference by enabling collective setting in setting a plurality of devices. A video conference terminal includes: a camera processing unit that generates an image to be transmitted to a video conference terminal on a counterpart side from an image that a camera images; a voice processing unit that generates a voice to be transmitted to the video conference terminal on the counterpart side from the voice that a microphone captures; and an input unit that receives an input of a conversation mode that a user selects, The conversation mode has at least a first conversation mode and a second conversation mode. In the first conversation mode, a transmitted image fetching angle and a transmitted voice capturing angle substantially match each other.

### RELATED APPLICATION

The present application claims priority to Japanese Patent Applications Numbers 2024-190519, filed on Oct. 30, 2024, and 2025-161315, filed Sep. 29, 2025, the disclosures of which are hereby incorporated by reference herein in its entirety.

### BACKGROUND OF THE INVENTION

### Field of the Invention

The present invention relates to a video conference terminal, a method for processing a video conference system, and a program.

### Description of the Related Art

Recently, a conference system that realizes a video conference has been popularly used. In the video conference, the conference is realized by performing the transmission and the reception of voices captured by a microphone and images imaged by a camera via a communication network.

In patent literature 1 described hereinafter, there is disclosed a video conference system where a panorama camera and a microphone array are combined, the panorama camera images the whole meeting room, and when a speaker is making a speech, an image of the speaker is automatically zoomed in and displayed.

### CITATION LIST

### Patent Literature

[Patent Literature 1]
   Japanese Patent Laid-Open No. 2024-077978

### SUMMARY OF THE INVENTION

With the increase in the number of conferences held in the form of a video conference, the importance of enabling a speaker to clearly convey his/her own voice to a specific person or a counterpart has increased. However, if only a noise cancelling function conventionally used is adopted, voices of other people around the speaker are also captured by a microphone. By taking into account such a situation, an attempt has been underway where a plurality of microphones are mounted on a video conference system, thereby providing a beam forming function that cuts voices of other people from directions different from the direction that the voice of the speaker advances. On the other hand, in a meeting room or the like, it is necessary to convey voices of other persons from all azimuths and various distances to the counterpart with whom the speaker is talking and hence, it is indispensable to switch an operation mode corresponding to a conference scene.

However, the simply switching an operation mode of a microphone is not enough to smoothly proceed a conference and hence, under a current situation, it has become necessary for a user to switch operations of the respective devices based on the conference scenes. For example, also with respect to an effect of a camera (a range that the camera images an image), although a wide angle, blurring of a background and the like may be unnecessary in a meeting room or the like, in a private home where the protection of privacy is important, it is preferable to set a virtual background including blurring of the background by narrowing an angle of view of a camera in the own house.

Further, recently, also with respect to an output of a speaker, in a conference where a speaker attends the conference at his/her seat, there is a need for a voice to be reproduced by focusing on the persons who attend the conference. On the other hand, in a conference held in a meeting room, there is a need for a reproduced voice to be controlled such that a voice of a counterpart can be easily heard regardless of the positions of the persons who attend the conference. That is, also with respect to an output of a speaker, it is desirable to switch an operation mode corresponding to a conference scene.

It is an object of the present invention to provide a video conference terminal, a method for processing a video conference system, and a program that can realize a smooth video conference by enabling collective setting for a plurality of devices by merely selecting a conversation mode corresponding to a video conference scene.

A video conference terminal according to the present application example is a video conference terminal that performs a video conference by transmitting and receiving an image and a voice between a local video conference terminal and a video conference terminal on a counterpart side, the video conference terminal comprising: an image generation means that generates an image to be transmitted to the video conference terminal on the counterpart side from an image that an imaging means images; a voice generation means that generates a voice to be transmitted to the video conference terminal on the counterpart side from the voice that a voice capturing means captures; and an input unit that receives an input of a conversation mode that a user selects, wherein the conversation mode has at least a first conversation mode and a second conversation mode, in the first conversation mode, a transmitted image fetching angle and a transmitted voice capturing angle substantially match each other, and in the second conversation mode, the transmitted voice capturing angle is set regardless of the transmitted image fetching angle.

A video conference terminal according to the present application example is the video conference terminal, further comprising a reproduced voice generation means that generates a voice regenerated by a voice reproduction means from a voice received from the video conference terminal on the counterpart side, wherein in the first conversation mode, the transmitted image fetching angle and the transmitted voice capturing angle, and an angle at which the reproduced voice is easily heard substantially match each other, and in the second conversation mode, the transmitted voice capturing angle and the angle at which the reproduced voice is easily heard are set regardless of the transmitted image fetching angle.

A method for processing a video conference system according to the present application example is a method for processing a video conference system that performs a video conference by transmitting and receiving an image and a voice between a local video conference terminal and a video conference terminal on a counterpart side, the method comprising: receiving processing where an input unit receives an input of a conversation mode that a user selects; image generation processing where an image generation processing unit generates an image to be transmitted from an image that an imaging means images; and voice generation processing where a voice to be transmitted is generated from a voice that a voice capturing means captures, wherein the conversation mode includes at least a first conversation mode and a second conversation mode, in the first conversation mode, a transmitted image fetching angle and a transmitted voice capturing angle substantially match each other, and in the second conversation mode, the transmitted voice capturing angle is set regardless of the transmitted image fetching angle.

A method for processing a video conference system according to the present application example is a method for processing a video conference system that performs a video conference by transmitting and receiving an image and a voice between a local video conference terminal and a video conference terminal on a counterpart side, the method comprising: receiving processing where an input unit receives an input of a conversation mode that a user selects; image generation processing step where an image generation processing unit generates an image to be transmitted from an image that an imaging means images; voice generation processing where a voice generation processing unit generates a voice to be transmitted is generated from a voice that a voice capturing means captures, and reproduced voice generation processing where a reproduced voice generation processing means generates a voice that is reproduced by a voice reproduction processing unit from a voice received from a video conference terminal on a counterpart side, the conversation mode includes at least a first conversation mode and a second conversation mode, in the first conversation mode, a transmitted image fetching angle, a transmitted voice capturing angle and an angle at which a reproduced voice can be easily heard substantially match each other, and in the second conversation mode, the transmitted voice capturing angle and the angle at which the reproduced voice can be easily heard are set regardless of the transmitted image fetching angle.

A program according to the present application example is a program that enables a video conference system to perform a video conference by transmitting and receiving an image and a voice between a local video conference terminal and a video conference terminal on a counterpart side, the program enabling a computer to execute: a step of receiving an input of a conversation mode that a user selects; an image generation step of generating an image to be transmitted from an image that an imaging means images; a voice generation step of generating a voice to be transmitted from a voice that a voice capturing means captures, and the conversation mode includes at least a first conversation mode and a second conversation mode, in the first conversation mode, a transmitted image fetching angle and a transmitted voice capturing angle substantially match each other, and in the second conversation mode, the transmitted voice capturing angle is set regardless of the transmitted image fetching angle.

A program according to the present application example is a program that enables a video conference system to perform a video conference by transmitting and receiving an image and a voice between a local video conference terminal and a video conference terminal on a counterpart side, the program enabling a computer to execute: a step of receiving an input of a conversation mode that a user selects; an image generation step of generating an image to be transmitted from an image that an imaging means images; a voice generation step of generating a voice to be transmitted from a voice that a voice capturing means captures, and a reproduced voice generation step of generating a voice reproduced by a voice reproduction means from the voice received from the video conference terminal on the counterpart side, the conversation mode includes at least a first conversation mode and a second conversation mode, in the first conversation mode, a transmitted image fetching angle, a transmitted voice capturing angle and an angle at which a reproduced voice can be easily heard substantially match each other, and an angle at which a reproduced voice can be easily heard substantially match each other, and in the second conversation mode, the transmitted voice capturing angle and the angle at which the reproduced voice can be easily heard are set regardless of the transmitted image fetching angle.

### Advantageous Effects Acquired by the Invention

The present invention can provide a video conference terminal, a method for processing a video conference system, and a program where a smooth video conference can be realized by enabling collective setting in setting a plurality of devices by merely selecting a conversation mode corresponding to a video conference scene.

### BRIEF DESCRIPTION OF THE DRAWINGS

FIG. 1 is a view illustrating the configuration of a video conference terminal according to an embodiment 1.

FIG. 2 is a block diagram illustrating the configuration of a control unit of the video conference terminal according to the embodiment 1.

FIG. 3 is a view for explaining contents set in the video conference terminal according to the embodiment 1 such as an angle of view and directivity angle.

FIG. 4 is a view for explaining one example of manipulations set in the video conference terminal according to the embodiment 1.

FIG. 5 is a view for explaining another example of manipulations set in the video conference terminal according to the embodiment 1.

FIG. 6 is a block diagram illustrating the configuration of a control unit of a video conference terminal according to an embodiment 2.

FIG. 7 is a view for explaining a setting example of an angle of view and a directivity angle of voice capturing in the video conference terminal according to the embodiment 2 in a standard mode, a private mode, a privacy mode, a meeting room mode (2) and a default.

FIG. 8 is a view for explaining an output of a speaker in the video conference terminal according to the embodiment 2

FIG. 9 is a view for explaining a setting example of an angle of view and a directivity angle of voice capturing in the video conference terminal according to an embodiment 3 in a standard mode, a private mode, a privacy mode, a meeting room mode (2) and a default.

### DETAILED DESCRIPTION OF THE PREFERRED EMBODIMENTS

### 1. Embodiment 1

Hereinafter, a video conference terminal 1 according to an embodiment 1 is described with reference to drawings.

### Overall Configuration of Video Conference Terminal 1

As illustrated in FIG. 1, the video conference terminal 1 includes an input unit 4, a camera device 15, an audio device 17, a display unit 13, a control unit 11 and a memory 12. The input unit 4, the camera device 15, the audio device 17, the display unit 13, the control unit 11 and the memory 12 are connected to each other via a bus 3. As the video conference terminal 1, for example, a personal computer (PC) is named. However, as long as the video conference terminal 1 has the above-mentioned configuration, the video conference terminal 1 is not limited to such a video conference terminal.

The input unit 4 functions as a user interface that enables a user to perform an input manipulation. Corresponding to a conversation mode that is inputted via the input unit 4 and selected by a user, the control unit 11 performs camera processing, audio device processing, and display processing with respect to the display unit 13 (for example, transition of a screen) in a video conference described later. The conversation mode includes a first conversation mode and a second conversation mode (standard mode), and the first conversation mode includes a plurality of sub conversation modes. The sub conversation mode includes a first sub conversation mode (private mode), a second sub conversation mode (privacy mode), a third sub conversation mode (meeting room mode (1)).

The camera device 15 includes an imaging means 25 (hereinafter, “imaging means 25” may also being referred to as “camera 25”), and a camera processing unit 26. The camera 25 includes a lens and an imaging means (CCD or CMOS), the lens forms a subject light, and the imaging means outputs the formed subject light as image signals R, G, B. The camera processing unit 26 includes an A/D converter, an image processing LSI, a memory and the like. The camera processing unit 26 controls driving timing, exposure and the like of the camera 25, and also has a function as an image forming unit that performs data processing (A/D conversion or the like) of the image signals R, G, B imaged by the camera 25. For example, by cutting out an image in a predetermined range from an imaged image that is imaged by the camera 25, an image to be transmitted to a video conference terminal (not illustrated in the drawing) on a counterpart side is formed. The camera processing unit 26 outputs the formed image to the control unit 11. The camera processing unit 26 also performs the formation of a virtual background image described later when necessary.

The audio device 17 includes: a plurality of voice capturing means 27 (hereinafter, “voice capturing means 27” being also referred to as “microphones 27”); at least one voice reproduction means 28 (hereinafter, “voice reproduction means 28” being also referred to “speakers 28”); and a voice processing unit 29. The microphone 27 captures voices and outputs voice data to the voice processing unit 29. The speakers 28 output voices corresponding to voice data outputted from the voice processing unit 29. The voice processing unit 29 includes an A/D converter, a D/A converter, a voice processing LSI and a memory and the like, and functions as a voice generation means that performs data processing (A/D conversion or the like) of voice data inputted from the microphones 27. The voice processing unit 29 performs signal processing of a directivity control based on spatial information of voices captured by the plurality of microphones 27 thus generating voices transmitted to a video conference terminal on a counterpart side (not illustrated in the drawing). The voice processing unit 29 outputs the generated voice data to the control unit 11, performs the D/A conversion of voice data (digital) inputted from the control unit 11, and outputs the converted voice to the speaker 28. The voice processing unit 29 performs noise cancelling processing when necessary in a standard mode, a private mode, a privacy mode and a meeting room mode (1). Further, the voice processing unit 29 can adjust sensitivity of voice capturing corresponding to a magnitude of a voice signal in the meeting room mode (1).

The display unit 13 includes a display panel (not illustrated in the drawing) and a touch panel (not illustrated in the drawing). The display panel is a liquid crystal panel and an organic electro luminescence (EL) panel, and displays manipulation buttons, a manipulation menu and the like. The touch panel functions as a user interface capable of inputting information, and is disposed in an overlapping manner with a display panel. A resistance-type touch panel or an electrostatic-type touch panel can be used.

In the memory 12, angles of view of the camera and directivities (directivity angles) of the microphones 27 in respective setting modes described later are stored in a linked manner. Further, setting mode programs (setting programs of angles of view and directivity angles corresponding to the modes) for a video conference described later, and a video conference program (for example, video conference applications and the like) are stored in the memory 12.

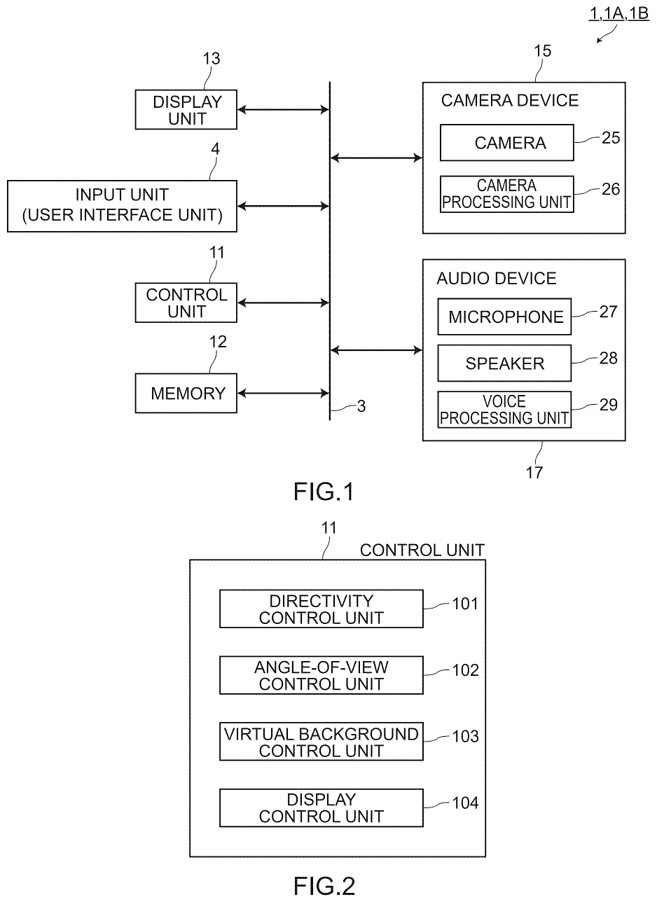

As illustrated in FIG. 2, the control unit 11 includes a directivity control unit 101, an angle of view control unit 102, a virtual background control unit 103 and a display control unit 104. By performing a setting mode program stored in the memory 12, the directivity control unit 101 performs processing for adjusting (controlling) directivities (transmitted voices capture angles) of the microphones 27 corresponding to the setting modes (directivity angle adjustment processing). The angle of view control unit 102 performs processing for adjusting (controlling) angles of view corresponding to the setting modes. The virtual background control unit 103 performs processing for setting backgrounds (blurred background of a user, virtual background) corresponding to setting modes. In the private mode and the privacy mode described later, the directivity angles of captured voices are adjusted by the directivity control unit 101 so that the directivity angles substantially match with the corresponding angles of view.

Processing of the video conference system in the control unit 11 is performed in accordance with following steps.
(1) The input unit 4 receives an input in a conversation mode that a user selects (reception processing).
(2) The camera processing unit 26 generates an image to be transmitted to a video conference terminal on a counterpart side from an image that the imaging means images (image generation processing).
(3) A voice to be transmitted to the video conference terminal on the counterpart side is generated from voices that the microphone 27 has captured (voice generation processing).
(4) The conversation mode includes a first conversation mode and a second conversation mode. In the first conversation mode, processing is performed where a transmitted image fetching angle (an angle at which an image to be transmitted is fetched) and a transmitted voice capturing angle (an angle at which a voice to be transmitted is captured) are made to substantially match each other. In the second conversation mode, processing that sets a transmitted voice capturing angle is set regardless of a transmitted image fetching angle.

Further, the program for executing the above-mentioned processing is stored as a setting mode program for video conference into the memory 12 in advance.

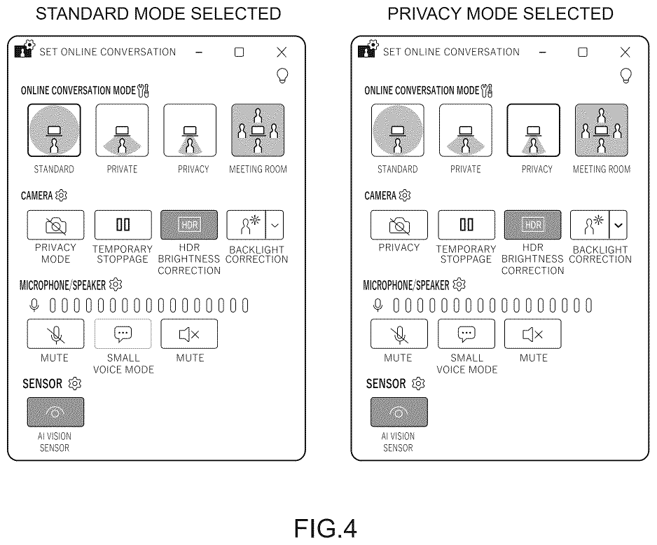

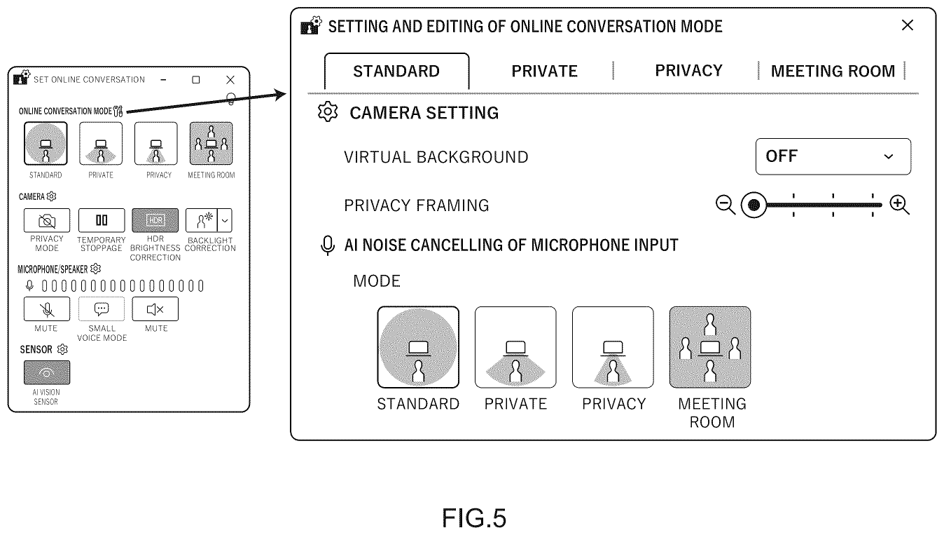

This setting mode can be switched to a standard mode, a private mode, a privacy mode and a meeting room mode (1) by selection due to a manipulation performed by a user via the input unit 4. The display control unit 104 has a function described later of updating an image of a selection icon and an image of adjustment icon that a user manipulates (for example, icons illustrated in FIG. 4 and FIG. 5), (for example, updating by highlighting a selected icon).

### Patterns of Setting Mode

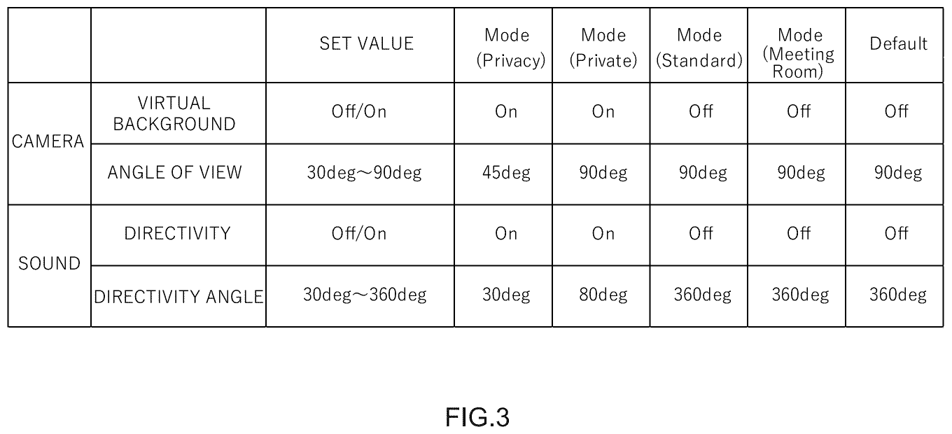

The standard mode, the private mode, the privacy mode and the meeting room mode (1) selected by a manipulation of the user are described hereinafter. FIG. 3 is a table that illustrates setting of examples of an angle of view, a directivity angle and the like in the standard mode, the private mode, the privacy mode, the meeting room mode (1) and default.

### Standard Mode

The standard mode is a mode where an angle at which a voice to be captured (hereinafter, referred to as “directivity angle of voice capturing) regardless of an angle at which an image imaged by the camera 25 that constitutes the local video conference terminal 1 is fetched (hereinafter, referred to as “angle of view”). First, when a video conference program (a video conference application) starts, a setting screen at the time of standard mode illustrated on a left side in FIG. 4 is displayed in the display unit 13. A right side in FIG. 4 illustrates a display screen after the privacy mode is selected.

When a standard mode is selected from four setting modes (standard mode, private mode, privacy mode, and meeting room mode (1)) disposed at an upper portion of a screen, an angle of view of the camera 25 and a directivity angle of voice capturing of the microphone 27 are set to an angle of view and a directivity angle of voice capturing corresponding to the standard mode stored in the memory 12 in advance. As optional setting contents, selection icons such as brightness correction, backlight correction, ON/OFF of mute of the microphone 27 and the speaker 28 and the like are displayed on the display unit 13 (see FIG. 4).

A directivity angle of voice capturing in the set standard mode is set so as to fetch voices from all azimuths (360 degrees as viewed from the vertical direction, hereinafter, the term “as viewed in the vertical direction” being omitted when the reference is made with respect to the directivity angle of voice capturing). However, the directivity angle of voice capturing may be suitably adjusted between 30 degrees and 360 degrees. An angle of view in the standard mode is set to 90 degrees as viewed in the vertical direction (hereinafter, the term “as viewed in the vertical direction” being omitted when the reference is made with respect to the angle of view). However, the angle of view may be set to an angle of view other than 90 degrees. In the example illustrated in FIG. 3, the angle of view is set to 90 degrees and the directivity is set to an OFF state (directivity angle of voice capturing: 360 degrees). This standard mode is set in the same manner as the default (initial mode).

The imaged image and captured voice are transmitted to a video conference terminal other than the local video conference terminal 1 (the video conference terminal on a counterpart side) via a communication network (not illustrated in the drawing). In the standard mode, setting of a virtual background can be set freely. However, a virtual background may be set to be turned on or turned off when necessary.

### Private Mode

The private mode is a mode where an angle of view at which an image imaged by the camera 25 that constitutes the local video conference terminal 1 is fetched and a directivity angle of voice capturing at which a voice is captured by the microphone 27 are made to substantially match each other. That is, the private mode is a mode that highlights a private effect (an effect of making an angle of view and a directivity angle of voice capturing to an image and a voice of a specific individual thus suppressing an influence of images and voices of persons other than the specified individual as much as possible). When the private mode is selected from four setting modes (standard mode, private mode, privacy mode, and meeting room mode (1)) disposed at the upper portion of the screen of the display unit 13, an angle of view of the camera 25 and a directivity angle of voice capturing of the microphone 27 are set to an angle of view and a directivity angle of voice capturing corresponding to the private mode stored in the memory 12 in advance. The private mode is the first conversation mode as described above, and is a first sub conversation mode.

For example, when the angle of view is 85 degrees, a directivity angle of voice capturing is also set so as to assume 85 degrees. Although the range of the angle of view and the range of the directivity angle of voice capturing may be set to values within a range of 90 degrees or less and 30 degrees or more, the directivity angle of voice capturing and the angle of view substantially match each other. The reason that the angle of view and the directivity angle of voice capturing are made to substantially match each other is that, by making the angle of view and the angle of voice capturing match each other, only the voice of the user is captured and surrounding noises and voices of other persons are not captured. That is, in a case where the angle of view is small, unless the directivity angle of the voice capturing is made small, the user hears voices surrounding a subject that is an object to be imaged and hence, it is difficult to acquire a private effect in a limited space. The term “substantially match each other” means that the angle of view and the directivity angle of voice capturing are made to match each other for achieving an object of capturing only a voice of the user, and the term does not mean that the angle of view and the angle of voice capturing are equal in a strict meaning of the term.

To further enhance a private effect, the angle of view and the directivity angle of the voice capturing can be made smaller. For example, in the example illustrated in FIG. 3, while the angle of view is set to 90 degrees, the directivity angle of the voice capturing angle is set to 80 degrees. Further, an angle-of-view setting range is 30 degrees to 90 degrees. The angle-of-view setting range can be freely set corresponding to a purpose of a conference, and the set content can be stored (registered) in the memory 12. By preparing several kinds of setting patterns with respect to the private mode in advance, it is possible to promptly set a specific private mode corresponding to a purpose of a conference. In the private mode, the setting of a virtual background can be made by selecting from virtual backgrounds stored in the memory 12 in advance in response to an instruction to a virtual background control unit 103 via the input unit 4. When it is unnecessary to set the virtual background, it is sufficient to turn off the virtual background control unit 103.

### Privacy Mode

The privacy mode is a mode in which an angle of view at which an image imaged by the camera 25 that constitutes a local video conference terminal (own video conference terminal) 1 is fetched and a directivity angle of voice capturing that captures a voice collected by the microphone 27 are made to substantially match each other. Compared to the private mode, the range of the angle of view and the range of the directivity angle of voice capturing are further narrowed so that a privacy effect is obtained. Here, the privacy effect is an effect that further suppresses influences of the images and the voices of other persons by combining the view of angle and the directivity angle of voice capturing to the image and the voice of the specific individual, and is an effect of further suppressing the influence of other people than the above-mentioned private effect. The meaning of “approximately match with” is substantially the same as the above-mentioned private mode. When the privacy mode is selected from four setting modes (standard mode, private mode, privacy mode, and meeting room mode (1)) disposed at the upper portion of the screen of the display unit 13, an angle of view of the camera 25 and a directivity angle of voice capturing of the microphone 27 are set to an angle of view and a directivity angle of voice capturing corresponding to the privacy mode stored in the memory 12 in advance. The privacy mode is the first conversation mode as described above, and is a second sub conversation mode.

For example, when the angle of view is 45 degrees, a directivity angle of voice capturing is also set to 45 degrees. That is, the angle of view and the directivity angle of voice capturing are set such that these angles match each other. To obtain a suitable privacy effect, it is preferable that the angle of view and the directivity angle of voice capturing substantially match each other within a range of 30 degrees to 45 degrees. However, the angle of view and the directivity angle of voice capturing substantially may be set such that these angles match each other within a range of 30 degrees to 90 degrees. A setting pattern of the angle of view and the directivity angle of voice capturing in the privacy mode is stored (registered) in the memory 12.

As illustrated in FIG. 5, in the privacy mode, a virtual background is set such that, when an instruction is inputted to the virtual background control unit 103 via the input unit 4, the camera processing unit 26 cuts out an image of a user excluding a background from an imaged image, synthesizes an image where the background is blurred or synthesizes a virtual background stored in the memory 12 in advance thus generating an image to be transmitted. The virtual background control unit 103 may be set to be turned on or off depending on necessity (see setting editing screen illustrated in FIG. 5).

### Meeting Room Mode (1)

In the meeting room mode (1), an angle of view at which an image imaged by the camera 25 that constitutes the local video conference terminal 1 is fetched and a directivity angle of voice capturing that captures voices collected by the microphone 27 substantially match each other. When the meeting room mode (1) is selected from four setting modes (standard mode, private mode, privacy mode, and meeting room mode (1)) disposed at the upper portion of the screen of the display unit 13, an angle of view of the camera 25 and a directivity angle of voice capturing of the microphone 27 are set to an angle of view and a directivity angle of voice capturing corresponding to the meeting room mode (1) stored in the memory 12 in advance. This meeting room mode (1) is automatically set when the meeting room mode (1) is selected by a manipulation of a user via the input unit 4. The meeting room mode (1) is the first conversation mode as described above, and is a third sub conversation mode.

In the meeting room mode (1), signal processing of a directivity control (beam forming) is performed based on a spatial information of voices that the plurality of voice capturing means capture and hence, processing is performed such that the voice can be clearly heard. Further, the voice of a person remote from the microphone 27 is processed such that a signal level of the voice is increased and the voice having an increased signal level is transmitted.

For example, in a case where a PC is disposed at the center of a table, an angle of view is set to 360 degrees, an angle of directivity of voice capturing is also set to 360 degrees so that the angle of view and the angle of voice capturing match each other. In a case where the PC is arranged at an end of table, for example, so as to perform a conference smoothly, the angle of view is set to 90 degrees, and the angle of directivity of voice capturing is set to 360 degrees (see FIG. 3) so that the angle of view and the angle of voice capturing are set such that these angles do not match each other. Further, in a case where the PC (camera, microphone) is arranged at the center of a table, for example, it is necessary to clearly capture voices of persons far from the PC and hence, it is necessary to adjust sensitivity of voice capturing corresponding to a magnitude of a voice signal.

### Advantageous Effects

### Advantageous Effects Acquired by Embodiment 1

According to the video conference terminal 1 of the embodiment 1, a video conference terminal that performs a video conference by transmitting and receiving an image and a voice between a local video conference terminal and a video conference terminal on a counterpart side. The video conference terminal 1 includes: the camera processing unit 26 that generates an image to be transmitted to the video conference terminal on the counterpart side from an image that the camera 25 images; the voice processing unit 29 that generates a voice to be transmitted to the video conference terminal on the counterpart side from the voice that the microphone 27 captures; and the input unit 4 that receives an input of a conversation mode that a user selects. The conversation mode has at least a first conversation mode (private mode, privacy mode) and a second conversation mode (standard mode). In the first conversation mode (private mode, privacy mode), a transmitted image fetching angle and a transmitted voice capturing angle substantially match each other, and in the second conversation mode, regardless of the transmitted image fetching angle, the transmitted voice capturing angle is set. Accordingly, a private effect and a privacy effect in a limited space in the private mode and the privacy mode are further highlighted, and voices in all azimuths can be captured in the standard mode thereby realizing the smooth video conference.

According to the video conference terminal 1 of the embodiment 1, the cameral processing unit 26 generates an image to be transmitted by cutting out an image within a predetermined range from an imaged image that the camera 25 images, and the voice processing unit 29 generates a voice to be transmitted by performing signal processing of a directivity control based on the spatial information of voices that the plurality of microphones 27 capture.

Accordingly, the image in a predetermined range can be highlighted by cutting out the image and, at the same time, the voice in the direction toward a designation can be highlighted.

According to the video conference terminal 1 of the embodiment 1, the first conversation mode has a plurality of sub conversation modes (private mode, privacy mode) and the plurality of respective sub conversation modes differ in an angle at which a voice to be transmitted. Accordingly, the degree of freedom for selecting a voice to be transmitted suitable for the conversation mode can be enhanced.

According to the video conference terminal 1 of the embodiment 1, as the sub conversation mode, the first sub conversation mode (private mode) is included, and a transmitted image fetching angle and a transmitted voice capturing angle in the first sub conversation mode fall within a range of 90 degrees or less around the imaging means as viewed in the vertical direction. Accordingly, it is possible to transmit a voice suitable for the private mode that can capture only a voice of a speaker and voices in the vicinity of the speaker and can transmit such voices.

According to the video conference terminal 1 of the embodiment 1, a transmitted image fetching angle in the second conversation mode (standard mode) falls within a range of 90 degrees or less around the camera 25 as viewed in the vertical direction, and a transmitted voice capturing angle is 360 degrees as viewed in the vertical direction. Accordingly, it is possible to perform the transmission of a suitable image and a suitable voice corresponding to the standard mode which corresponds to a type set in general.

According to the video conference terminal 1 of the embodiment 1, as the sub conversation mode, the second sub conversation mode (the privacy mode where only a voice of a speaker and a voice in the vicinity of the speaker are captured and can be transmitted) is included. A transmitted image fetching angle and a transmitted voice capturing angle in the first sub conversation mode (private mode) falls within a range of 90 degrees or less around the camera 25 as viewed in the vertical direction. A transmitted image fetching angle and a transmitted voice capturing angle in the second sub conversation mode (privacy mode) fall within a range of 45 degrees or less around the camera 25. Accordingly, suitable image and voice corresponding to the private mode can be transmitted and, at the same time, the suitable image and the voice corresponding to the privacy mode can be transmitted.

According to the video conference terminal 1 of the embodiment 1, in the first sub conversation mode (private mode) and the above-mentioned second sub conversation mode (privacy mode), the camera processing unit 26 cuts out an image of a user from an imaged image excluding a background, and synthesizes the image whose background is blurred or the virtual image is synthesized, and generates an image to be transmitted. Accordingly, a private effect or a privacy effect is highlighted corresponding to a private mode or a privacy mode thus only the voice of the user can be properly captured without picking up a surrounding sound and voices of other persons.

According to the video conference terminal 1 of the embodiment 1, as the sub conversation mode, the third sub conversation mode (meeting room mode (1)) is included. In the third sub conversation mode (meeting room mode (1)), a transmitted image fetching angle and a transmitted voice capturing angle are 360 degrees around the camera 25 as viewed in the vertical direction. In the third sub conversation mode, the voice processing unit 29 adjusts sensitivity of voice capturing corresponding to a magnitude of a signal of the voice. Accordingly, an image and a voice suitable for the meeting room mode (1) can be transmitted.

### 2. Embodiment 2

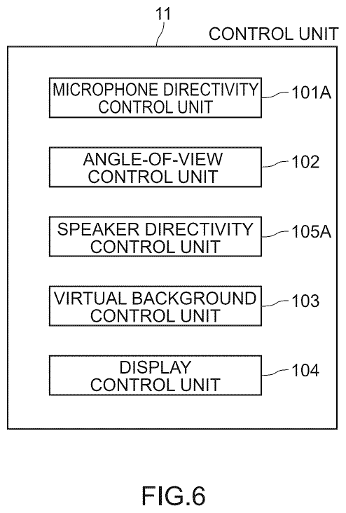

Next, the configuration of the video conference terminal 1A according to embodiment 12 is described with reference to FIG. 1, FIG. 4, and FIG. 6 to FIG. 8. FIG. 6 is a block diagram illustrating the configuration of a control unit 11 that the video conference terminal 1A includes.

The video conference terminal 1A according to the embodiment 2 differs from a video conference terminal 1 according to the embodiment 1 with respect to a point that the video conference terminal 1A includes reproduced voice generation means that generates a voice generated from a voice received from the video conference terminal on a counterpart side by the voice reproducing means, or a point that the video conference terminal 1A includes a meeting room mode (2) in place of the meeting room mode (1). The video conference terminal 1A according to the embodiment 2 is equal to the video conference terminal 1 according to the embodiment 1 with respect to other points. Accordingly, in the description of the video conference terminal 1A, only the points which make the configuration of the video conference terminal 1A differ from the configuration of the video conference terminal 1 are described. With respect to the description of the video conference terminal 1A, points that make configuration of the video conference terminal 1A differ from the configuration of the video conference terminal 1 are described, and points that the configuration of the video conference terminal 1A shares with the configuration of the video conference terminal 1 are omitted when appropriate.

An audio device 17 of the video conference terminal 1A includes two or more speakers 28 (see FIG. 1). Two or more speakers 28 output voices respectively corresponding to voice data outputted from the voice processing unit 29.

The voice processing unit 29 includes an A/D converter, a D/A converter, a voice processing LSI, and a memory and the like. The voice processing unit 29 has a function as a voice generating means that performs dada processing of voice data inputted from the microphone 27, and has a function as a reproduced voice generation means for generating a voice generated by the speaker 28 from a voice received from the video conference terminal on a counterpart side.

As the reproduced voice generation means, the voice processing unit 29 performs an acoustic control on a voice that is received from the video conference terminal on a counterpart side depending on a conversation mode that the user selects (see FIG. 4). To be more specific, the voice processing unit 29 can, by performing the acoustic control, adjust an angle at which a voice reproduced by the speaker 28 can be easily heard within a range from a small angle of 30 degrees, for example, on the front side of the video conference terminal 1A to 360 degrees around the entire circumference of the video conference terminal 1A. With such adjustment, the angle of directivity of voice capturing and the angle of directivity of reproduction can be made substantially equal.

The control unit 11 has, as described in FIG. 6, a microphone directivity control unit 101A, an angle-of-view control unit 102, a speaker directivity control unit 105A, a virtual background control unit 103, and a display control unit 104. The microphone directivity control unit 101A in the video conference terminal 1A corresponds to the directivity control unit 101 in the video conference terminal 1.

The microphone directivity control unit 101A performs processing for adjusting directivity (transmitted voice capturing angle) of the microphone 27 that corresponds to a mode selected by a user. The speaker directivity control unit 105A performs processing for adjustment on a voice received from the video conference terminal of a counterpart such that an angle at which voice reproduced by the speaker 28 can be easily heard becomes an angle of directivity of reproduction that corresponds to a mode set by a user.

The video conference terminal 1A has, as the conversation mode, the first conversation mode and the second conversation mode. In the first conversation mode, an angle of view and an angle of directivity of voice capturing substantially match each other. On the other hand, in the second conversation mode, the angle of directivity of voice capturing and an angle of directivity of reproduction are set.

The first conversation mode includes a first sub conversation mode and a second sub conversation mode. On the other hand, the second conversation mode includes a fourth sub conversation mode and a fifth sub conversation mode.

An angle of view, an angle of directivity of voice capturing, and an angle of directivity of reproduction in the first sub conversation mode, as viewed in the vertical direction, fall within a range of 90 degrees around the imaging means. In the description made hereinafter, the first sub conversation mode of the first conversation mode is expressed as “private mode”.

An angle of view, an angle of directivity of voice capturing, and an angle of directivity of reproduction in the second sub conversation mode, as viewed in the vertical direction, fall within a range of 45 degrees around the imaging means. In the description made hereinafter, the second sub conversation mode of the first conversation mode is expressed as “privacy mode”.

An angle of view in the fourth sub conversation mode, as viewed in the vertical direction, falls within a range of 90 degrees around the imaging means. Further, the angle of directivity of voice capturing and the angle of directivity of reproduction are, as viewed in the vertical direction, 360 degrees. In the description made hereinafter, the fourth sub conversation mode of the second conversation mode is expressed as “meeting room mode (2)”.

An angle of view in the fifth sub conversation mode, as viewed in the vertical direction, falls within a range of 90 degrees around the imaging means. The angle of directivity of voice capturing is 360 degrees as viewed in the vertical direction, and the angle of directivity of reproduction falls within a range of 90 degrees or less as viewed in the vertical direction. In the description made hereinafter, the fifth sub conversation mode of the second conversation mode is expressed as “standard mode”.

The video conference terminal 1A includes the above-mentioned four setting modes (standard mode, private mode, privacy mode and meeting room mode (2)) selected by a manipulation of a user. Three setting modes other than the meeting room mode (2) is substantially equal to the video conference terminal 1 except for that an angle of directivity of reproduction by the reproduced voice generation means is set to fall within above-mentioned numerical value range. Accordingly, only the meeting room mode (2) is described as a representative mode.

### Meeting Room Mode (2)

The meeting room mode (2) is a mode where an angle that captures voice to be transmitted (angle of directivity of voice capturing) and an angle at which voice reproduced by the speaker 28 can be easily heard (angle of directivity of reproduction) are set. In the meeting room mode (2), the angle of directivity of capturing voice and the angle of directivity of reproduction are set to 360 degrees.

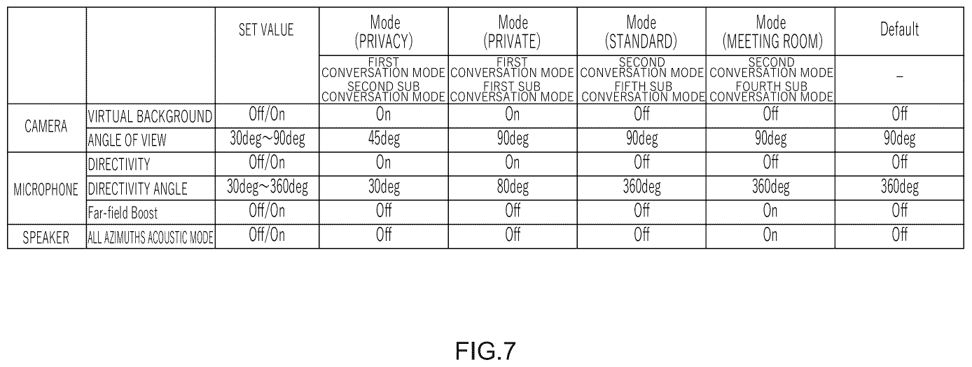

When the meeting room mode (2) is selected among four setting modes (standard mode, private mode, privacy mode, and meeting room mode (2)), an angle of view of the camera 25, an angle of directivity of voice capturing of the microphone 27 and an angle of directivity of reproduction of the speaker 28 are set to the angle of view, the angle of directivity of voice capturing and the angle of directivity of reproduction that correspond to the meeting mode (2) stored in the memory 12. In the meeting room mode (2) according to the embodiment 2, the angle of view is set to 90 degrees, the angle of directivity of voice capturing is set to 260 degrees, and the angle of directivity of reproduction is set to 360 degrees (see FIG. 7, a numerical value of the angle of directivity of the reproduction not being described in FIG. 7).

In the meeting room mode (2), in the voice processing unit 29, an acoustic control is performed on a voice received from the video conference terminal on a counterpart side. To be more specific, the voice processing unit 29 adjusts respective voices reproduced by two or more speakers 28 such that voices reproduced by the speaker 28 can be easily heard even at two or more positions at which the angles differ around the video conference terminal 1A. By adjusting the respective voices, reproduced by two or more speakers 28, it is possible to provide a voice that can be easily heard also by persons who participate in the conference at two or more positions where the angles differ.

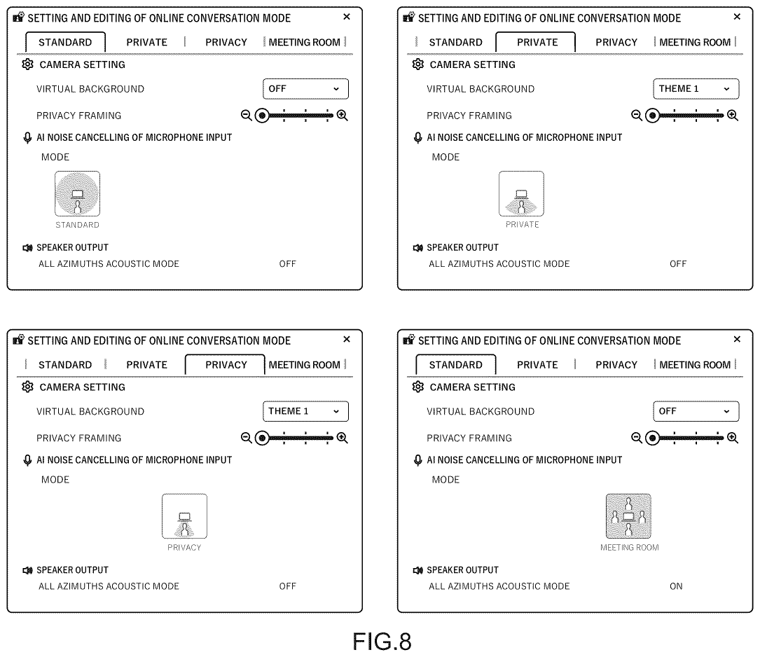

In a preferred aspect, the voice processing unit 29 adjusts the respective voices reproduced by two or more speaker 28 such that the angles at which voices reproduced by two or more speakers can be easily heard become 360 degrees all around the video conference terminal 1A (see FIG. 8, speaker output: all azimuth acoustic mode: ON). With such processing, it is possible to provide voices can be easily heard also by persons participating in the conference in all azimuths (positions) with respect to the video conference terminal 1A.

In the meeting room mode (2), it is preferable to set an angle of view, that is, a transmitted image fetching range is set to an arbitrary angle depending on the kind of the camera 25 to be used and the usage state of the camera 25 in the conference. In a case where a 360 degree camera capable of imaging the entire azimuths is used as the camera 25, an angle of view can be set withing a range of 360 degrees or less around the imaging unit as viewed in the vertical direction. By setting the angle of view within the range of 360 degrees or less around the imaging unit, all persons participating in the conference as participants can be imaged by the camera 25, and an imaged image can be transmitted to the video conference terminal on a counterpart side. Further, it is possible to provide voices received from the video conference terminal on a counterpart side to all persons participating in the conference by converting the voice into a voice into that can be easily heard by an acoustic control.

When viewed in the vertical direction, the angle of view may be set to a value within a range of 90 degrees or less around the imaging unit. By setting the angle of image to the value within the range of 90 degrees or less around the imaging unit, even in a case where a camera whose angle range in which imaging can be performed is substantially 90 degrees is used as the camera 25, the meeting room mode (2) can be performed. Further, it is possible to provide an acoustic control such that a voice received from the video conference terminal on a counterpart side becomes a voice that persons participating in the conference outside an imaging range of the camera 25 can also easily hear.

Further, in the meeting room mode (2), in the same manner as the meeting room mode (1) in the embodiment 1, it is preferable that a voice can be clearly heard by performing signal processing that controls voice capturing (beam forming) based on spatial information of voices that a plurality of voice capturing means (microphones 27) capture.

Further, it is preferred that the voice generation means of the voice processing unit 29 adjusts sensitivity of voice capturing corresponding to a magnitude of a captured voice signal. For example, a voice of a person at a position remote from the voice capturing means (microphones 29) tends to have a small signal level and hence, it is preferred to transmit the voice signal to the video conference terminal on a counterpart side after performing processing to increase a signal level (Far-field Boost) (see FIG. 7, microphone/Far-field Boost: On).

### Advantageous Effects Acquired by Embodiment 2

The video conference terminal 1A according to the embodiment 2 further includes reproduced voice generation means that generates a voice reproduced by the voice reproducing means (speaker 28) from a voice received from the video conference terminal on a counterpart side. In the first conversation mode, an angle of view, an angle of directivity in transmission and an angle of directivity in reproduction are set such that these angles substantially match each other. In the second conversation mode, an angle of directivity of voice capturing and an angle of directivity of reproduction are set regardless of an angle of view.

The video conference terminal 1A includes the reproduced voice generation means and, further, in the second conversation mode, the angle of directivity of voice capturing and an angle of directivity of reproduction are set regardless of an angle of view. Accordingly, it is possible to provide an acoustic control that converts a voice received from the video conference terminal on a counterpart side into a voice that can be easily heard also by a person who participates in the conference at a position other than the front side of the video conference terminal 1A (a region outside the angle of view).

According to a preferred aspect of the video conference terminal 1A, an angle of view (an angle at which a transmitted image is fetched) in the second conversation mode falls within a range of 360 degrees or less around the imaging unit as viewed in the vertical direction. Accordingly, it is possible to image the whole persons participating in the conference by the camera 25 and, to transmit an imaged image to the video conference terminal on a counterpart side. Further, it is possible to provide the whole persons participating in the conference with the voice received from the video conference terminal on a counterpart side that is converted into a voice that can be easily heard by an acoustic control.

According to a preferred aspect of the video conference terminal 1A, an angle of view (an angle at which a transmitted image is fetched) in the second conversation mode falls within a range of 90 degrees or less around the imaging means in the vertical direction. Accordingly, even in a case where a camera having imaging angle range of substantially 90 degrees is used as the camera 25, the meeting room mode (2) can be applied. Further, it is possible to provide persons participating in the conference outside the imaging range of the camera 25 with the voice received from the video conference terminal on a counterpart side that is converted into a voice that can be easily heard by an acoustic control.

A preferred aspect of the video conference terminal 1A has the meeting room mode (2) (fourth sub conversation mode), and the reproduced voice capturing generation means performs an acoustic control such that a voice can be easily heard at two or more positions that differ in an angle around the video conference terminal as viewed in the vertical direction. Accordingly, it is possible to provide a voice that can be easily heard also to persons participating in the conference at two or more positions where the angles differ around the video conference terminal 1A.

According to a preferred aspect of the video conference terminal 1A, in the meeting room mode (2) (the fourth sub conversation mode), it is preferred that the voice generation means adjusts sensitivity of voice capturing corresponding to a magnitude of a captured voice signal. Accordingly, in the meeting room mode (2), it is possible to transmit a voice that is captured by the voice capturing means to the video conference terminal on a counterpart side after adjusting the voice to a preferred voice volume.

### 3. Embodiment 3

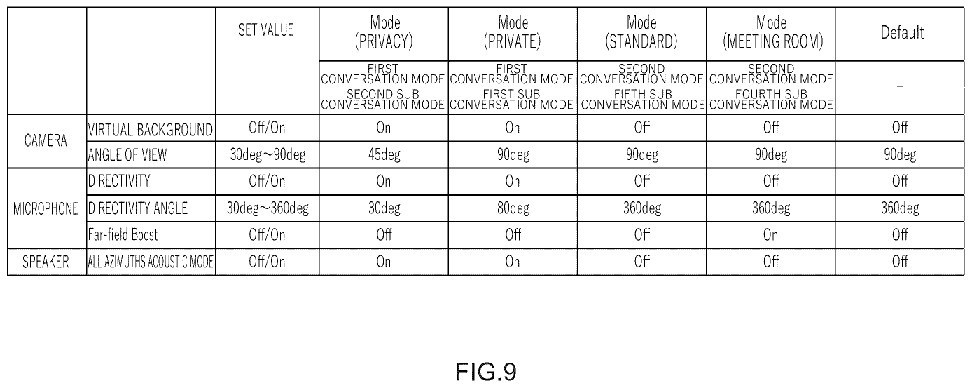

Next, the video conference terminal 1B according to the embodiment 3 is described with reference to FIG. 1 to FIG. 9. FIG. 9 is a block diagram illustrating the configuration of the control unit 11 that the video conference terminal 1A includes.

The video conference terminal 1B according to the embodiment 3 differs from the video conference terminal 1A according to the embodiment 2 with respect to a means that controls “an angle of directivity of reproduction”. The video conference terminal 1B according to the embodiment 2 is the same as the video conference terminal 1A according to the embodiment 2 with respect to other points.

Accordingly, in the description of the video conference terminal 1B, points that make the configuration of the video conference terminal 1B differ from the configuration of the video conference terminal 1A are described, and points that are shared by the configuration of the video conference terminal 1B and the video conference terminal 1A are omitted when appropriate.

The video conference terminal 1B includes, as the speaker 28 (see FIG. 1), a directional speaker. The directional speaker is a speaker that can transmit a voice to a target area limited to a specific area. By using the directional speaker as the speaker 28, it is possible to transmit a clear voice to the target area. As the directional speaker, a line array speaker, a flat panel speaker, an ultrasonic speaker and the like can be exemplified.

The video conference terminal 1B uses a directional speaker in the private mode and the privacy mode among four setting modes (standard mode, private mode, privacy mode and meeting room mode (2)) (indicated as “On” in a column “directional speaker” in FIG. 9).

With the use of the directional speaker, it is possible to control the directivity of a reproduced voice in the direction toward a front side of the video conference terminal 1B. That is, by limiting an angle range where the speaker 28 transmits a voice to a narrow angle on the front side of the video conference terminal 1B, an angle of directivity of reproduction, an angle of view and an angle of directivity of voice capturing are made to match each other and hence, the privacy mode and the private mode in the speaker 28 can be realized.

On the other hand, in the standard mode and the meeting room mode (2), a directional speaker is not used (indicated as “Off” in the column “directional speaker” in FIG. 9. Accordingly, it is possible to reproduce a voice that is received from a video conference terminal on a counterpart side as a voice that can be easily heard by also persons positioned at places other than the front side of the video conference terminal 1B and to provide such a voice to these persons.

### Advantageous Effects Acquired by Embodiment 3

According to the video conference terminal 1B of the embodiment 3, the video conference terminal 1B further includes the directional speaker, and angle of directivity of voice capturing (angle at which transmitted voice is captured) and an angle of directivity of a voice at which the directional speaker reproduces match each other.

With the use of the directional speaker, it is possible to control the directivity of a reproduced voice in the direction toward the front side of the video conference terminal 1B. That is, by limiting an angle range in which the speaker 28 reproduces a voice to a narrow range on a front side of the video conference terminal 1B, the angle of directivity of reproduction, the angle of view and the angle of directivity of voice capturing are made to match each other. Accordingly, the privacy mode and the private mode can be realized with respect to the speaker 28.

### 4. Embodiment 4

Next, a method for processing the video conference system (1) according to the embodiment 4 is described with reference to FIG. 1 to FIG. 5. The method for processing the video conference system (1) is a method for processing a video conference system preferably applicable to a video conference system that uses the video conference terminal.

The method for processing the video conference terminal (1) is a method for processing a video conference system that performs a video conference by transmitting and receiving an image and a voice between the own video conference terminal and a video conference terminal on a counterpart side not illustrated in the drawing. In the method for processing the video conference terminal (1), a reception processing that receives an input of a conversation mode that a user selects, and an image generation processing that generates an image to be transmitted from an image that an imagine means images, and a voice generation processing that generates a voice to be transmitted from a voice that a voice capturing means captures.

The conversation mode includes the first conversation and the second conversation mode (standard mode). In the first conversation mode, an angle of view (a transmitted image fetching angle) and an angle of directivity of voice capturing (a transmitted voice capturing angle) are set to substantially match each other. Further, in the second conversation mode, the angle of directivity of voice capturing is set regardless of an angle of view.

The first conversation mode includes a plurality of sub conversation modes. As the sub conversation modes, the first conversation mode includes a first sub conversation mode (private mode), a second sub conversation mode (privacy mode), and a third sub conversation mode (meeting room mode (1)).

FIG. 5 illustrates examples of an angle of view and a directivity angle of voice capturing in four modes (standard mode, private mode, privacy mode, and meeting room mode (1)).

### Advantageous Effects Acquired by Embodiment 4

According to a method for processing a video conference system (1) according to the embodiment 4, in the first conversation mode (private mode, privacy mode), a transmitted image fetching angle and a transmitted voice capturing angle substantially match each other. A private effect and a privacy effect in a limited space can be further highlighted. Further, in the second conversation mode, the transmitted voice capturing angle is set regardless of the transmitted image fetching angle. Accordingly, voices in all azimuths can be captured and hence, a smooth video conference can be realized.

### 5. Embodiment 5

Next, a method for processing the video conference system (2) according to an embodiment 5 is described with reference to FIG. 1 and FIG. 6 to FIG. 9. The method for processing the video conference system (2) is a method for processing a video conference system preferably applicable to a video conference system that uses the video conference terminal.

The method for processing the video conference system (2) according to the embodiment 5 differs from the method for processing the video conference system (1) according to the embodiment 4 with respect to the point that the reproduced voice generation processing unit performs reproduced voice generation processing that generates a voice reproduced by the voice reproduction processing unit from a voice received from a voice received from the video conference terminal on a counterpart side, and the point that method for processing the video conference system (2) according to the embodiment 5 includes the meeting room mode (2) in place of the meeting room mode (1). The method for processing the video conference system (2) according to the embodiment 5 is equal to the method for processing the video conference system (1) according to the embodiment 4 with respect to other points. Accordingly, in the description of the method for processing the video conference system (2) according to the embodiment 5, the points that make the method for processing the video conference system (2) different from the method for processing the video conference system (1) are described, and the description of the points shared by the configuration of the method for processing the video conference system (1) and configuration of the method for processing the video conference system (2) is appropriately omitted.

The method for processing the video conference system (2) is a method for processing a video conference system that performs a video conference by transmitting and receiving an image and a voice between a local video conference terminal and a video conference terminal on a counterpart side not illustrated in the drawing, wherein the method further performs reproduced voice generation processing in addition to reception processing, image generation processing and voice generation processing. The reproduced voice generation processing is processing that generates a reproduced voice from a voice received from the video conference terminal on a counterpart side.

The method for processing the video conference system (2) includes a first conversation mode and a second conversation mode. In the first conversation mode, an angle of view (a transmitted image fetching angle), a directivity angle of voice capturing (transmitted voice capturing angle), and a directivity angle of reproduction (an angle at which reproduced voice is easily heard) are set such that these angles substantially match each other. Further, in the second conversation mode, the directivity angle of voice capturing and the directivity angle of reproduction are set regardless of the angle of view.

The first conversation mode includes a plurality of sub conversation modes. As the sub conversation modes, the first conversation mode includes a first sub conversation mode (private mode) and a second sub conversation mode (privacy mode).

The second conversation mode includes a plurality of sub conversation modes. As the sub conversation modes, the second conversation mode includes the fourth conversation mode (meeting room mode (2)) and the fifth conversation mode (standard mode).

FIG. 7 illustrates examples of an angle of view and a directivity angle of voice capturing in four modes (standard mode, private mode, privacy mode, and meeting room mode (2)).

### Advantageous Effects Acquired by Embodiment 5

According to the method for processing the video conference system (2) of the embodiment 5, in the first conversation mode (private mode, privacy mode), a private effect and a privacy effect can be further highlighted. On the other hand, in the meeting room mode (2), it is possible to provide an acoustic control that converts a voice received from the video conference terminal on a counterpart side into a voice that can be easily heard also by persons participating in the conference at positions other than a front side of the video conference terminal 1A.

### 6. Embodiment 6

Next, a program (1) according to the embodiment 6 is described with reference to FIG. 1 to FIG. 5. The program (1) is a program that is suitably applicable to a video conference system that uses the video conference terminal 1A and/or a video conference terminal 1B.

The program (1) is a program that enables a computer to function as a video conference system that performs a video conference by receiving and transmitting an image and a voice between a local video conference terminal and a video conference terminal on a counterpart side. The program allows the computer to execute: a step of receiving an input of a conversation mode that a user selects; an image generation step of generating an image to be transmitted from an image that an imaging means images; and a voice generation step of generating a voice to be transmitted from a voice that the voice capturing means captures.

The conversation mode has at least the first conversation mode, and the second conversation mode (standard mode). In the first conversation mode, an angle of view (transmitted image fetching angle) and a directivity angle of voice capturing (transmitted voice capturing angle) are set such that these angles substantially match each other. Further, in the second conversation mode, directivity angle of voice capturing is set regardless of an angle of view.

The first conversation mode includes a plurality of sub conversation modes. As the sub conversation modes, the first conversation mode includes a first sub conversation mode (private mode), a second sub conversation mode (privacy mode), and a third sub conversation mode (meeting room mode (1)).

FIG. 5 illustrates examples of an angle of view and a directivity angle of voice capturing in four modes (standard mode, private mode, privacy mode, and meeting room mode (1)).

### Advantageous Effects Acquired by Embodiment 6

According to the program (1) of the embodiment 6, in the first conversation mode (private mode, privacy mode), a transmitted image fetching angle and a transmitted voice capturing angle substantially match each other. Accordingly, a private effect and a privacy effect in a limited space can be further highlighted. Further, in the second conversation mode, the transmitted voice capturing angle is set regardless of the transmitted image fetching angle. Accordingly, voices in all azimuths can be captured and hence, a smooth video conference can be realized.

### 7. Embodiment 7

A program (2) according to an embodiment 7 is described with reference to FIG. 1 and FIG. 6 to FIG. 9. The program (2) is a program that is preferably applicable to a video conference system that uses the video conference terminal 1A and/or the video conference terminal 1B.

The program (2) according to the embodiment 7 differs from the program (1) according to the embodiment 6 with respect to a point that the program (2) enables the computer to execute a reproduced voice generation step of generating a voice reproduced by the voice reproduction means from a voice received from the video conference terminal on a counterpart side, and a point that the conversation mode has the meeting room mode (2) in place of the meeting room mode (1). The program (2) according to the embodiment 7 is the same as the program (1) according to the embodiment 6 with respect to other points. Accordingly, in the description of the program (2), only the points that make the configuration of the program 2 differ from the configuration of the program 1 are described, and the description of the points of the configuration of the program 2 shared in common by the configuration of the program 1 is appropriately omitted.

The program (2) is a program that enables a computer to function as a video conference system that performs a video conference by receiving and transmitting an image and a voice between a local video conference terminal and a video conference terminal on a counterpart side not illustrated in the drawing. The program (2) enables the computer to execute: a reception processing of receiving an input of a conversation mode that a user selects; an image generation processing of generating an image to be transmitted from an image that an imaging means images; a voice generation processing of generating a voice to be transmitted from a voice that a voice capturing means captures; and a reproduced voice generation processing of generating a voice regenerated from a voice received from the video conference terminal on the counterpart side.

The program (2) has, as a conversation mode, a first conversation mode and a second conversation mode. In the first conversation mode, an angle of view (a transmitted image fetching angle), directivity angle of voice capturing (a transmitted voice capturing angle) and a directivity angle of reproduction (an angle at which a reproduced voice can be easily heard) are set such that these angles substantially match each other.

The first conversation mode includes a plurality of sub conversation modes. That is, the first conversation mode includes, as the sub conversation modes, a first sub conversation mode (a private mode) and a second sub conversation mode (a privacy mode).

The second conversation mode also includes a plurality of sub conversation modes. That is, the second conversation mode includes, as the sub conversation modes, a fourth sub conversation mode (a meeting room mode (2)) and a fifth sub conversation mode (a standard mode).

FIG. 7 illustrates examples of an angle of view and a directivity angle of voice capturing in four modes (a standard mode, a private mode, a privacy mode, and a meeting room mode (2)).

### Advantageous Effects Acquired by Embodiment 7

According to the program (2) of the embodiment 7, in the first conversation mode (private mode, privacy mode), a private effect and a privacy effect can be further highlighted. In the meeting room mode (2), it is possible to provide an acoustic control to convert a voice received from the video conference terminal on a counterpart side to a voice that can be easily heard also by persons participating in the conference at positions other than a front side of the video conference terminal 1A.

The present invention is not limited to the above-mentioned embodiments, and various modifications can be carried out without departing from the gist of the present invention.

What is claimed is:

1. A video conference terminal that performs a video conference by transmitting and receiving an image and a voice between a local video conference terminal and a video conference terminal on a counterpart side, the video conference terminal comprising:
an image generation means that generates an image to be transmitted to the video conference terminal on the counterpart side from an image that an imaging means images;
a voice generation means that generates a voice to be transmitted to the video conference terminal on the counterpart side from the voice that a voice capturing means captures; and
an input unit that receives an input of a conversation mode that a user selects, wherein
the conversation mode has at least a first conversation mode and a second conversation mode,
in the first conversation mode, a transmitted image fetching angle and a transmitted voice capturing angle substantially match each other, and
in the second conversation mode, the transmitted voice capturing angle is set regardless of the transmitted image fetching angle.

2. The video conference terminal according to claim 1, wherein
the image generation means generates an image to be transmitted by cutting out an image in a predetermined range from an imaged image that is imaged by the imaging means, and
the voice generation means generates a voice to be transmitted by performing signal processing of a directivity control based on spatial information of voices that a plurality of the voice capturing means capture.

3. The video conference terminal according to claim 1, wherein
the first conversation mode includes a plurality of sub conversation modes, and
the plurality of sub conversation modes have angles at which the voice to be transmitted is captured differ from each other.

4. The video conference terminal according to claim 3, wherein
the first conversation mode has, as the sub conversation mode, a first sub conversation mode, and
the transmitted image fetching angle and the transmitted voice capturing angle in the first sub conversation mode fall within a range of 90 degrees or less around the imaging means as viewed in a vertical direction.

5. The video conference terminal according to claim 1, wherein
the transmitted image fetching angle in the second conversation mode falls within a range of 90 degrees or less around the imaging means as viewed in a vertical direction, and the transmitted voice capturing angle in the second sub conversation mode is 360 degrees around the imaging means as viewed in a vertical direction.

6. The video conference terminal according to claim 3, wherein
the first conversation mode further includes, as the sub conversation mode, a second sub conversation mode, and
the transmitted image fetching angle and the transmitted voice capturing angle in the first sub conversation mode fall within a range of 90 degrees or less around the imaging means as viewed in the vertical direction, and
the transmitted image fetching angle and the transmitted voice capturing angle in the second sub conversation mode fall within a range of 45 degrees or less around the imaging means as viewed in the vertical direction.

7. The video conference terminal according to claim 6, wherein
in the first sub conversation mode and the second sub conversation mode, the image generation means generates the image to be transmitted by cutting out an image of a user excluding a background from the imaged image, and synthesizing an image where the background is blurred or synthesizing a virtual background.

8. The video conference terminal according to claim 4, wherein
the first conversation mode has, as the sub conversation mode, a third sub conversation mode, and
the transmitted image fetching angle and the transmitted voice capturing angle in the third sub conversation mode are 360 degrees around the imaging means as viewed in the vertical direction, and
the voice generation means adjust sensitivity of voice capturing corresponding to a magnitude of a signal of the voice in the third sub conversation mode.

9. The video conference terminal according to claim 1, further comprising a reproduced voice generation means that generates a voice regenerated by a voice reproduction means from a voice received from the video conference terminal on the counterpart side, wherein
in the first conversation mode, the transmitted image fetching angle and the transmitted voice capturing angle, and an angle at which the reproduced voice is easily heard substantially match each other, and
in the second conversation mode, the transmitted voice capturing angle and the angle at which the reproduced voice is easily heard are set regardless of the transmitted image fetching angle.

10. The video conference terminal according to claim 9, wherein
in the second conversation mode, the transmitted image fetching angle falls within a range of 360 degrees or less around the imaging means as viewed in the vertical direction, and the transmitted voice capturing angle and the angle at which the reproduced voice is easily heard are set to 360 degrees as viewed in the vertical direction.

11. The video conference terminal according to claim 10, wherein
in the second conversation mode, the transmitted image fetching angle falls within a range of 90 degrees or less around the imaging means as viewed in the vertical direction, and the transmitted voice capturing angle and the angle at which the reproduced voice is easily heard are set to 360 degrees as viewed in the vertical direction.

12. The video conference terminal according to claim 11, wherein
the reproduced voice generation means has a fourth sub conversation mode where the reproduced voice generation means performs an acoustic control such that the voice can be easily heard at two or more positions that differ in an angle around the video conference terminal as viewed in a vertical direction.

13. The video conference terminal according to claim 12, wherein
in the fourth sub conversation mode, the voice generation means adjusts sensitivity of voice capturing corresponding to the magnitude of a signal of the voice.

14. The video conference terminal according to claim 9, further comprising a directional speaker, wherein
the voice reproduction means is configured such that the transmitted voice capturing angle and the directivity angle of a voice in the directional speaker in the first conversation mode substantially match each other.

15. A method for processing a video conference system that performs a video conference by transmitting and receiving an image and a voice between a local video conference terminal and a video conference terminal on a counterpart side, the method comprising:
receiving processing where an input unit receives an input of a conversation mode that a user selects;
image generation processing where an image generation processing unit generates an image to be transmitted from an image that an imaging means images; and
voice generation processing where a voice to be transmitted is generated from a voice that a voice capturing means captures, wherein
the conversation mode includes at least a first conversation mode and a second conversation mode,
in the first conversation mode, a transmitted image fetching angle and a transmitted voice capturing angle substantially match each other, and
in the second conversation mode, the transmitted voice capturing angle is set regardless of the transmitted image fetching angle.

16. A method for processing a video conference system that performs a video conference by transmitting and receiving an image and a voice between a local video conference terminal and a video conference terminal on a counterpart side, the method comprising:
receiving processing where an input unit receives an input of a conversation mode that a user selects;
image generation processing where an image generation processing unit generates an image to be transmitted from an image that an imaging means images;
voice generation processing where a voice generation processing unit generates a voice to be transmitted from a voice that a voice capturing means captures, and
reproduced voice generation processing where a reproduced voice generation processing means generates a voice that is reproduced by a voice reproduction processing unit from a voice received from a video conference terminal on a counterpart side,
the conversation mode includes at least a first conversation mode and a second conversation mode,
in the first conversation mode, a transmitted image fetching angle, a transmitted voice capturing angle and an angle at which a reproduced voice can be easily heard substantially match each other, and
in the second conversation mode, the transmitted voice capturing angle and the angle at which the reproduced voice can be easily heard are set regardless of the transmitted image fetching angle.

17. A program that enables a video conference system to perform a video conference by transmitting and receiving an image and a voice between a local video conference terminal and a video conference terminal on a counterpart side, the program enabling a computer to execute:
a step of receiving an input of a conversation mode that a user selects;
an image generation step of generating an image to be transmitted from an image that an imaging means images;
a voice generation step of generating a voice to be transmitted from a voice that a voice capturing means captures, and
the conversation mode includes at least a first conversation mode and a second conversation mode,
in the first conversation mode, a transmitted image fetching angle and a transmitted voice capturing angle substantially match each other, and
in the second conversation mode, the transmitted voice capturing angle is set regardless of the transmitted image fetching angle.

18. A program that enables a video conference system to perform a video conference by transmitting and receiving an image and a voice between a local video conference terminal and a video conference terminal on a counterpart side, the program enabling a computer to execute:
a step of receiving an input of a conversation mode that a user selects;
an image generation step of generating an image to be transmitted from an image that an imaging means images;
a voice generation step of generating a voice to be transmitted from a voice that a voice capturing means captures, and
a reproduced voice generation step of generating a voice reproduced by a voice reproduction means from the voice received from the video conference terminal on the counterpart side,
the conversation mode includes at least a first conversation mode and a second conversation mode,
in the first conversation mode, a transmitted image fetching angle, a transmitted voice capturing angle and a angle at which a reproduced voice can be easily heard substantially match each other, and
in the second conversation mode, the transmitted voice capturing angle and the angle at which the reproduced voice can be easily heard are set regardless of the transmitted image fetching angle.
